(19) United States
(12) Patent Application Publication
(10) Pub. No.: US 2013/0047722 A1
(43) Pub. Date: Feb. 28, 2013

(54) DRY AND WET BULB PSYCHROMETER

(71) Applicant: Chen-Heng CHENG, Taichung City (TW)

(72) Inventor: Chen-Heng CHENG, Taichung City (TW)

(73) Assignee: AZ INSTRUMENT CORP., Taichung City (TW)

(21) Appl. No.: 13/276,407

(22) Filed: Oct. 19, 2011

(30) Foreign Application Priority Data
Aug. 29, 2011 (TW) 100130944

(51) Int. Cl. G01N 25/62

(52) U.S. Cl. 73/335.08

(57) ABSTRACT

A dry and wet bulb psychrometer consists of a first temperature sensor, a second temperature sensor, a water tank, a water absorbing member, a computing circuit and a display screen. The water absorbing member is connected to the second temperature sensor and dipped in water in the water tank. The computing circuit is electrically coupled with the first and second temperature sensors for computing a humidity value by using the temperature values sensed by the first and second temperature sensors and displaying the computed result on the display screen for reading by a user. Thus, the dry and wet bulb psychrometer is convenient for application to provide high-precision level measurement.

### BACKGROUND OF THE INVENTION

1. Field of the Invention

The present invention relates to an instrument used for measuring the moisture content, or humidity, in the environmental air and more particularly, to a dry and wet bulb psychrometer, which allows the user to directly read the measured value.

2. Description of the Related Art

A conventional dry and wet bulb psychrometer generally includes a dry bulb temperature sensor and a wet bulb temperature sensor. The dry bulb temperature sensor is exposed to the environmental air to be measured. The wet bulb temperature sensor has the sensing tip covered with an absorbent material (for example, cotton) that is connected to a water tank by a water absorbing member (for example, cotton cord) for absorbing water and transferring it to the absorbent material. Because evaporation of water moisture carries away heat energy and the speed of evaporation depends on the surrounding humidity, the user can obtain the humidity value through a psychrometric charts by the use of the dry bulb temperature and the wet bulb temperature. However, an error may be caused when reading the measured values by naked eyes. Further, it is complicated to find the humidity value by means of using the measured data on a chart. There are manufacturers to electronize certain component parts of a psychrometer, facilitating reading. However, as the dry bulb temperature sensor, the wet bulb temperature sensor and the water tank are separately installed, the whole structure of a conventional psychrometer is heavy and large. It is still not convenient for delivery or installation. Further, a large psychrometer must be used with a high-power electric fan so that surrounding air can be effectively drawn into the inside of the psychrometer for measurement. However, the use of a high-power electric fan consumes much electric energy, i.e., the psychrometer must obtain the necessary working voltage from city power supply, limiting the field of application.

In recent years, wet sensitive resistor or wet sensitive capacitor may be used for making a fully electronic type psychrometer. However, a wet sensitive resistor or wet sensitive capacitor may fail easily under a high temperature environment where moisture in air tends to be condensed into water. Thus, the field of application of a fully electronic type psychrometer of this type is limited.

### SUMMARY OF THE INVENTION

The present invention has been accomplished under the circumstances in view. It is the main object of the present invention to provide a dry and wet bulb psychrometer, which is convenient for a wide field of applications.

It is another object of the present invention to provide a dry and wet bulb psychrometer, which has the dry bulb temperature sensor, the wet bulb temperature sensor and the water tank arranged together in a single housing, convenient for carrying and application.

To achieve these and other objects of the present invention, a dry and wet bulb psychrometer consists of a first temperature sensor, a second temperature sensor, a water tank, a water absorbing member, a computing circuit and a display screen. The first temperature sensor and the second temperature sensor are accommodated in the housing. The water tank is formed inside the housing. The water absorbing member is connected to the second temperature sensor and partially dipped in water in the water tank. The computing circuit is electrically coupled with the first temperature sensor and the second temperature sensor, and adapted for computing a humidity value by using the temperature values sensed by the first temperature sensor and the second temperature sensor. The display screen is electrically coupled to the computing circuit and adapted for displaying the humidity value computed by the computing circuit.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an oblique elevational view of a dry and wet bulb psychrometer in accordance with the present invention.

FIG. 2 is an exploded view of the dry and wet bulb psychrometer in accordance with the present invention.

FIG. 3 is a front view of the dry and wet bulb psychrometer in accordance with the present invention.

FIG. 4 is a left side view of the dry and wet bulb psychrometer in accordance with the present invention.

FIG. 5 is a right side view of the dry and wet bulb psychrometer in accordance with the present invention.

FIG. 6 is a sectional view of the dry and wet bulb psychrometer in accordance with the present invention.

### DETAILED DESCRIPTION OF THE INVENTION

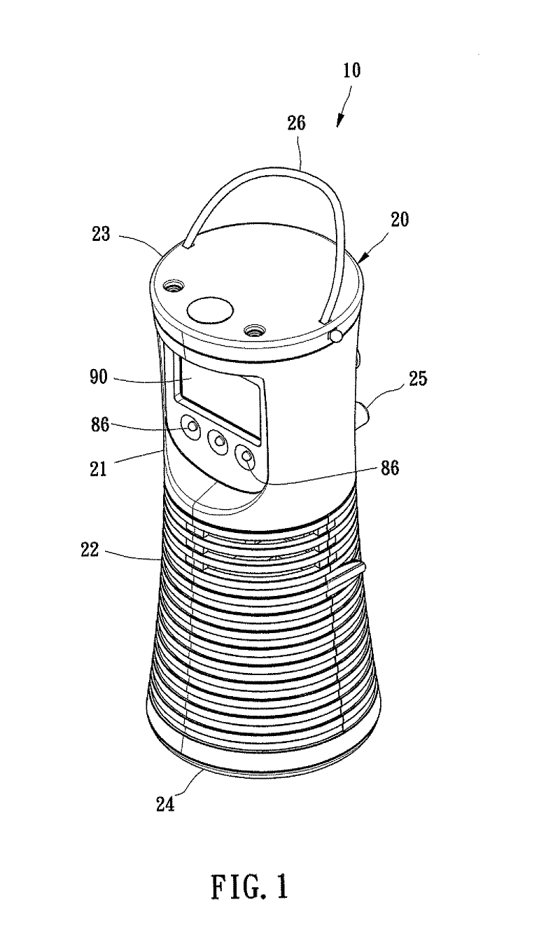

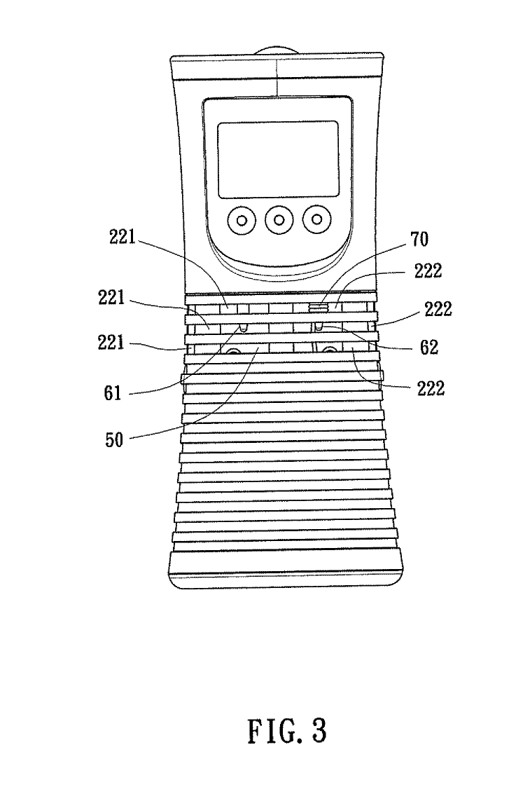

Referring to FIGS. 1-3, a dry and wet bulb psychrometer 10 in accordance with the present invention is shown comprising a housing 20, and a rack 30, a water tank 40, an electric fan 50, a first temperature sensor 61 a second temperature sensor 62, a water absorbing member 70, a computing circuit 80 and a display screen 90 accommodated in the housing 20.

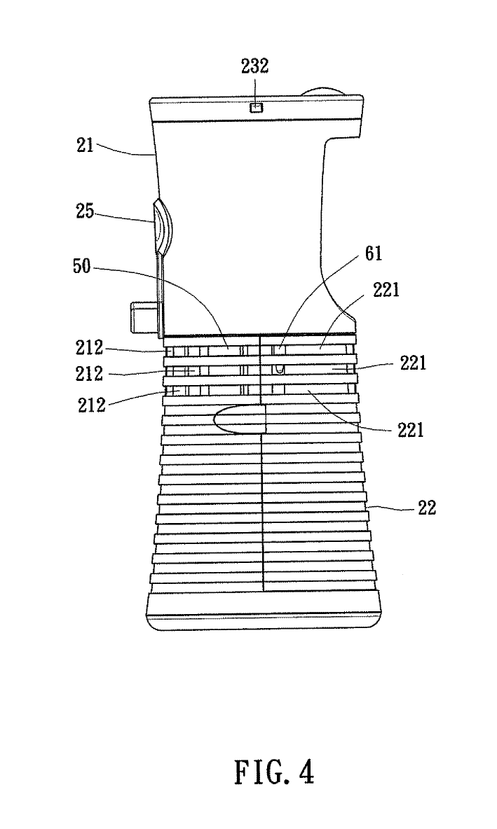

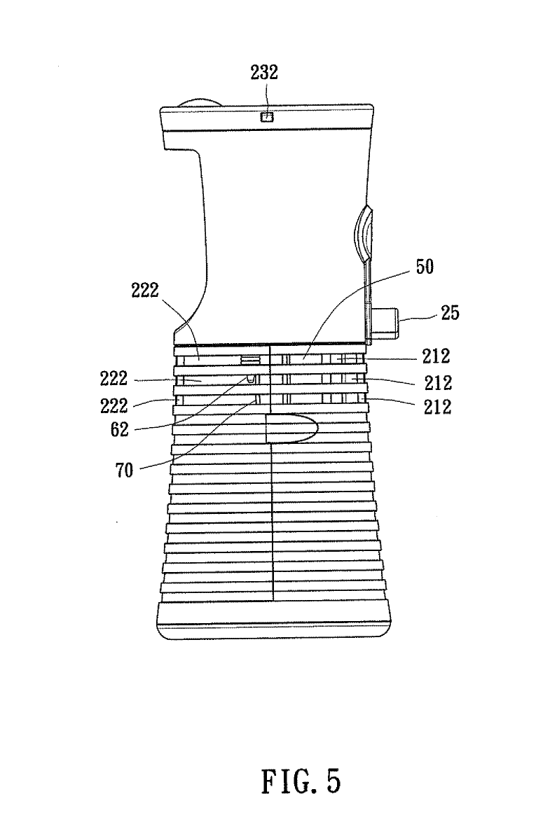

The housing 20 comprises a body 21, a front cover 22, a top cover 23 and a bottom cover 24. The front cover 22 has three first front openings 221 and three second front openings 222 respectively defined in the left upper area and right upper area thereof in a symmetric manner. The first front openings 221 extend horizontally and are disposed at different elevations. Similarly, the second front openings 222 extend horizontally and are disposed at different elevations corresponding to the first front openings 221. The body 21 defines a plurality of rear openings 212 corresponding to the first front openings 221 and the second front openings 222 (see FIG. 4 and FIG. 5), and a window opening 214. Further, the body 21 is provided with a plug member 25. The top cover 23 defines two through holes 232. Further, a hanging rope 26 is fastened to the two through holes 232 (see FIG. 1).

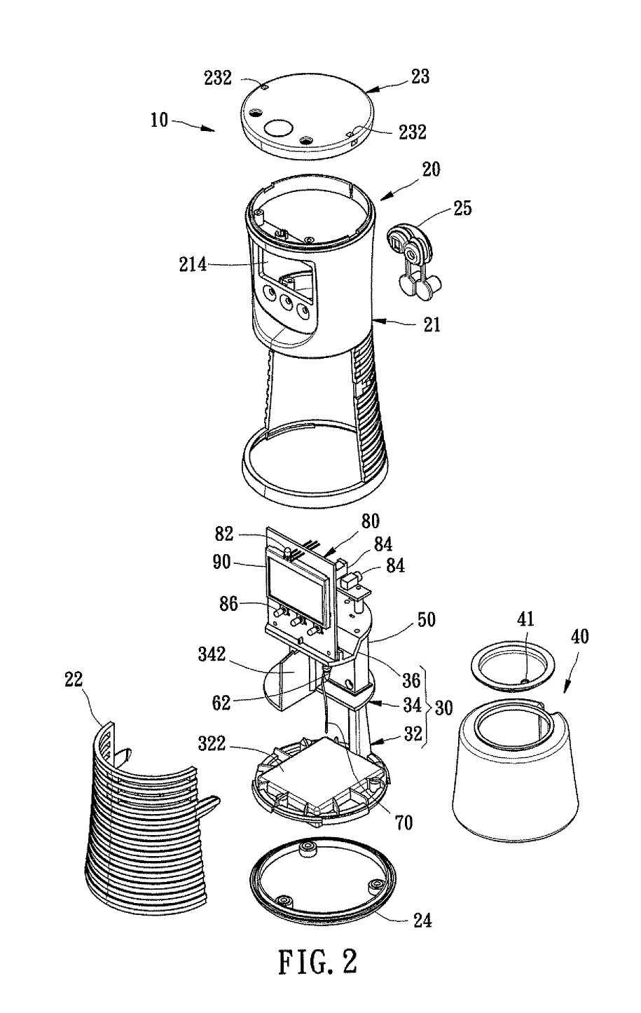

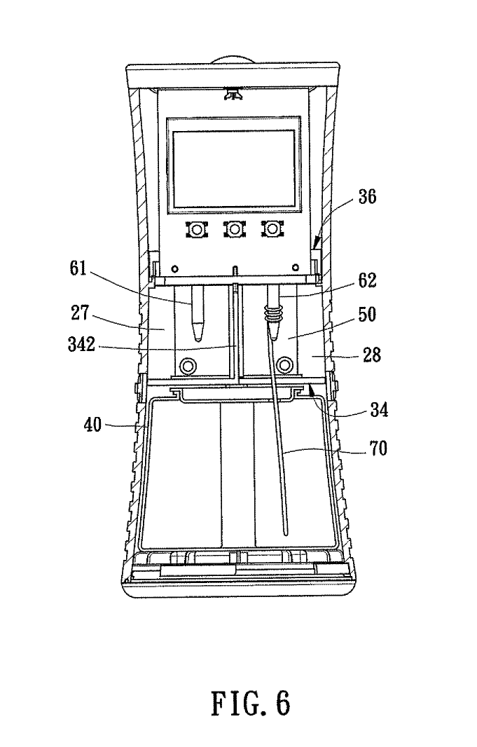

The rack 30 comprises a bottom frame member 32, a spacer frame member 34 and a top frame member 36. The bottom frame member 32 defines a battery accommodation chamber 322 in the bottom side thereof that is closed by the bottom cover 24. The water tank 40 is set between the battery accommodation chamber 322 and the spacer frame member 34. The electric fan 50 is set between the top frame member 36 and the spacer frame member 34. As shown in FIG. 2 and FIG. 6, the spacer frame member 34 comprises a forwardly extending spacer plate 342. Thus, a first accommodation space 27 is defined between the electric fan 50 and the aforesaid first front openings 221; a second accommodation space 28 is defined between the electric fan 50 and the aforesaid second front openings 222; the spacer plate 342 is disposed between the first accommodation space 27 and the second accommodation space 28.

The first temperature sensor 61 and the second temperature sensor 62 are fixedly mounted at the top frame member 36 and respectively projecting into the first accommodation space 27 and the second accommodation space 28. The water absorbing member 70 can be, for example, but not limited to, a cotton cord, having one end thereof suspending in the second accommodation space 26 and wound round the second temperature sensor 62 and the other end thereof inserted through a through hole 41 in the water tank 40 and dipped in water in the water tank 40 for absorbing water from the water tank 40 and transferring it to the periphery of the second temperature sensor 62. The temperature values sensed by the first temperature sensor 61 and the second temperature sensor 62 are the dry bulb temperature value and the wet bulb temperature value in the area where the dry and wet bulb psychrometer 10 is positioned.

The computing circuit 80 is arranged at the top side of top frame member 36 and electrically coupled with the first temperature sensor 61 and the second temperature sensor 62 for computing the humidity in the air in the area by using the temperature values measured by first temperature sensor 61 and the second temperature sensor 62. The computing circuit 80 further comprises a light-emitting device 82 and two jacks 84. The light-emitting device 82 emits light to the outside through the top cover 23 during operation of the dry and wet bulb psychrometer 10. The jacks 84 include one power jack for the connection of a power cable, and a signal jack for the connection of a signal transmission cable. When the jacks 84 are not used, they can be sealed by the plug member 25.

The display screen 90 is mounted and electrically coupled with the computing circuit 80. Further, the computing circuit 80 comprises three operating buttons 86 exposed to the outside of the body 21 of the housing 20 for operation by a user to switch the display content of the display screen 90.

Under the effect of the electric fan 50, surrounding air goes through the first front openings 221 and the second front openings 222 into the first accommodation space 27 and the second accommodation space 28 and then out of the housing 20 through the rear openings 212. At this time, the computing circuit 80 fetches the readings of the first temperature sensor 61 and the second temperature sensor 62 and computes the humidity in the air, and then displays the computed result on the display screen 90 for reading by the user. This design avoids the drawback of reading error of the conventional dry and wet bulb psychrometers and facilitates application. Further, the dry and wet bulb psychrometer 10 eliminates the use of an electronic sensitive resistor or capacity for moisture measurement, broadening the application field. Further, the manufacturer can design the electric fan 50 to run intermittently at a predetermined time interval, for example, to run per every half hour, saving energy consumption. As the first temperature sensor 61 and the second temperature sensor 62 are respectively disposed in the first accommodation space 27 and the second accommodation space 28 and separated by the spacer plate 342, water evaporation in the second accommodation space 28 does not affect the sensing operation of the first temperature sensor 61, assuring a high level of measuring accuracy. Further, the first front openings 221 and the second front openings 222 are elongated openings, facilitating flowing of air currents through the first accommodation space 27 and the second accommodation space 28 rapidly and evenly, and therefore, the dry and wet bulb psychrometer 10 can rapidly and accurately reflects the surrounding humidity.

As the first temperature sensor 61, second temperature sensor 62 and water tank 40 of the dry and wet bulb psychrometer 10 are all arranged inside the housing 20 and other components are miniaturized, the dry and wet bulb psychrometer 10 of the present invention has a relatively smaller size and weight when compared to conventional dry and wet bulb psychrometers. Further, the battery (not shown) at the bottom side of the housing 20 provides the dry and wet bulb psychrometer 10 with the necessary working voltage. Thus, the dry and wet bulb psychrometer 10 can be conveniently carried by a person, facilitating application. Further, the electric fan 50 is designed to run intermittently, saving energy consumption. Thus, the dry and wet bulb psychrometer 10 can work for a long period of time without using city power supply.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A dry and wet bulb psychrometer, comprising:
a housing;
a first temperature sensor mounted inside said housing;
a second temperature sensor mounted inside said housing;
a water tank formed inside said housing;
a water absorbing member connected to said second temperature sensor and extending into said water tank;
a computing circuit electrically coupled with said first temperature sensor and said second temperature sensor and adapted for computing a humidity value by using the temperature values sensed by said first temperature sensor and said second temperature sensor; and
a display screen electrically coupled to said computing circuit and adapted for displaying the humidity value computed by said computing circuit.

2. The dry and wet bulb psychrometer as claimed in claim 1, wherein said housing comprises a first accommodation space, a second accommodation space and a spacer board, said first accommodation space and said second accommodation space being kept in communication with the space outside said housing, said spacer plate being disposed between said first accommodation space and said second accommodation space; said first temperature sensor and said second temperature sensor are respectively disposed in said first accommodation space and said second accommodation space.

3. The dry and wet bulb psychrometer as claimed in claim 2, further comprising an electric fan mounted inside said housing for causing air circulation between said first accommodation space and said second accommodation space and the space outside said housing.

4. The dry and wet bulb psychrometer as claimed in claim 2, wherein said housing defines a plurality of first front openings and second front openings, said first front openings and said second front openings extending horizontally; said first accommodation space is defined between said first front openings and said electric fan; said second accommodation space is defined between said second front openings and said electric fan.

5. The dry and wet bulb psychrometer as claimed in claim 1, wherein said housing further comprises two through holes, and a hanging rope fastened to said two through holes.
